(19) United States
(12) Patent Application Publication
(10) Pub. No.: US 2001/0025256 A1
(43) Pub. Date: Sep. 27, 2001

(54) System, method and apparatus for integrated access to electronic works

(76) Inventors: Mike Oliphant, San Diego, CA (US); Dan Kaplan, San Diego, CA (US); John Knott, El Cajon, CA (US)

Correspondence Address: Derek J. Jardieu, HOWREY SIMON ARNOLD & WHITE, LLP, Box 34, 1299 Pennsylvania Avenue, N.W., Washington, DC, 20004-2402, US

(21) Appl. No.: 09/760,714

(22) Filed: Jan. 17, 2001

Related U.S. Application Data
(60) Provisional application No. 60/175,159, filed on Jan. 7, 2000.

(51) Int. Cl. G06F 17/60

(52) U.S. Cl. 705/26

(57) ABSTRACT

A system, method, and apparatus for integrating a user's access to electronic works from multiple services or sources. The invention is preferably practiced at a content location, a host location and/or a user location. In a preferred embodiment, the user has access to works at the host through an account and access to additional works at the content location. To integrate access to works available from the host location and the content location, the content location searches its own memory for electronic works available to the user. When the search is complete, the content location transmits a message to the host. The message preferably includes user identification information needed to access the user's account with the host, an address of the content location and an identifier or work code for each work identified in the search. The message may also include some meta-data. In response, the host links the information received with the user's account. When a user accesses his or her account and requests a work, the host identifies the work and its location with a uniform resource locator or other indicator. The host also sends a message or request to the content location to deliver the work identified by the uniform resource locator to the user location. Next, the content location delivers the requested work to the user location via streaming, downloading, or any other type of electronic delivery.

### RELATED APPLICATIONS

This application claims the benefit of U.S. Provisional Application No. 60/175,159, entitled SYSTEM AND METHOD FOR ENABLING GLOBAL ACCESS AND INSTANTANEOUS LISTENING TO DIGITAL AUDIO, filed on Jan. 7, 2000, U.S. Nonprovisional Application No. 09/615,591, entitled SYSTEM AND METHOD FOR PROVIDING ACCESS TO ELECTRONIC WORKS, filed on Jul. 13, 2000, U.S. Nonprovisional Application No. 09/615,590, entitled DISTRIBUTION SYSTEM FOR ELECTRONIC WORKS, filed on Jul. 13, 2000, and U.S. Nonprovisional Application No. 09/722,407, entitled A SUBSCRIPTION AND ACCOUNTING SYSTEM, each of which is herein incorporated by reference.

### BACKGROUND OF THE INVENTION

1. Field of the Invention

The present invention relates generally to providing improved access to varying forms of content stored in varying locations. More specifically, the present invention relates to a system, method and apparatus for providing integrated access to electronic works stored by multiple content providers. In a preferred embodiment, the integrated access is provided through an interface supported by a host that is further a content provider of electronic works.

2. Related Art

As networks such as the Internet have become more widely accessible, one industry that has enjoyed increasing popularity is the industry related to providing online access to multimedia content. Such content includes audio works in such formats as wave (WAV), Moving Picture Experts Group [MPEG]-1, Layer-3 (MP3), and Real Audio (RM); video or audio-visual works in formats including MPEG, Audio Video Interleave (AVI), etc.; and combinations thereof.

As a result of this increasing popularity, individuals and groups have introduced systems supporting web sites, on such networks as the Internet, for providing to a user online access to the various types of electronic multimedia works. Often, a user will have accounts with one or more such web sites from which these multimedia works may be accessed. Furthermore, a typical user will also have electronic content stored at one or more personal locations, such as in memory in a personal computer at home and/or at the office. Thus, a problem arises in that it is often difficult for a user to retrieve all content that the user is entitled to access from all locations. For example, when at home, the user may be able to access electronic works from local memory, but must login online to access electronic works accessible only from an online account. Likewise, when a user is logged in to an online account from the office computer, the user cannot access electronic content stored at home.

What is needed is a system for integrating access to electronic works stored at a plurality of locations such that they are accessible from any networked location. Furthermore, such integrated access would preferably be provided through an online account, such that all the options thereby available, such as playlists, etc., would continue to be at the disposal of the user.

### SUMMARY OF THE INVENTION

The present invention provides a system, method and apparatus for integrated access to electronic works stored at a plurality of locations such that they are accessible from any networked location. In a preferred embodiment, a user has access to content from multiple sources, such as a remote content source or location and a host. In this embodiment, the user inputs information into the remote content source, such as the user's identification and/or the general location of electronic works at the remote source. The information may be input via a user terminal at the remote content location. With this information, the user terminal searches the remote content source for the electronic works. For each electronic work the user terminal finds, the user terminal records a specific location of the work. The remote content source may also store hyperlinks or bookmarks to electronic works at other network locations or other hosts. Thus, in one embodiment, the user terminal further searches the remote content source for these hyperlinks or bookmarks and stores them as electronic work locations.

The user terminal may also extract additional information from the stored content, such as the file name, meta-data, or other potentially useful information. The meta-data preferably includes the name of the work, the type of the work, the author, and other helpful information. If this information is not stored within the electronic work, the user terminal may create such meta-data from the name of the file, the location of the file, the name of the folder containing the file or other contextual information.

Next, the user terminal assigns identifiers to each of the stored or identified works. In a preferred embodiment, the identifiers are assigned sequentially. Alternatively, the identifiers may also be assigned randomly, based on the file name, based on the meta-data, or many other ways.

Once a work is assigned an identifier, the user terminal sends a message to the host. The message may be sent automatically or at the user's request. The message preferably includes user identification information required for accessing the user's account with the host, an identifier for at least one electronic work, and a network address for the remote content source. The user identification may be a username and password, for example. The network address is preferably an Internet Protocol address.

When the host receives the message, the host links this information to the user's account based on the user identification and stores the information contained within the message in memory. The host may link the information with a variety of database structures and tables. The host may link multiple remote content locations, such as the user's home and office, to a given account.

Since the network address of a remote content location may change periodically, the user terminal may also refresh or update the address or location of the stored or identified works. The updates may occur periodically, every time a user accesses their account with the host, or any other reasonable number of times. The need for updates depends on the stability of the network address.

In addition to remote content sources, the user's account with the host may also contain content or electronic works from a variety of other sources. For example, the user's account may provide access to works stored at or available through the host itself. The works available from the host may be authorized through a variety of sources. In a preferred embodiment, the user may receive authorization to access the works at the host by special promotions, confirmation numbers obtained from retailers, the host receiving an authorization message from a retailer, or the user demonstrating ownership of the work in a variety of other ways. Each work associated with the user's account has a unique identifier.

Once the links to content stored at the remote content location or locations are integrated with content from other sources, a user may access all of the linked content from anywhere the user has access to the host.

To access this content, a user logs on to the user's account with the host and selects the works that he or she wants to access. The user may select the works individually or the user may create a playlist including content from any of the content sources linked to the account. For example, a playlist may include works stored at remote content locations, works stored at the host, or works stored at any other network locations (ex., other web sites or other personal archives).

When the user selects a work, the user terminal sends a request to the host for access to the work. Based on this request, the host creates another identifier, such as a uniform resource locator, to locate the work. If the work is stored at a remote content location, the identifier is created in part based on the address of the remote content location and the work identifier. If the work is stored at the host, the identifier is created based on the file name or location.

Once the URL or identifier is generated, if the requested electronic work is stored at a remote content location, the host sends this identifier back to the user location. The identifier may be a hyperlink to the network location of the requested work, it may be the location of the requested work at the remote content location, or it may be a combination of both. Alternatively, it may only be a sequentially assigned identifier sent with a message including additional information, such as the location of the content location and/or the location of the work at the content location. Once the user location receives the message from the host, the user location contacts the remote content source using the information within the message or identifier, and asks it to deliver the requested work.

In an alternative embodiment, the host may forward this user's requests to the remote location itself. The request is typically forwarded based on the address of the remote content location stored in memory. The request may include the work identifier and the address where the user wants to receive the work.

To receive this message with the identifier from the host, the user terminal listens on a network port for such incoming requests using a specified protocol, such as HTTP. The message from the host preferably includes the address of the remote content location with the work and the identifier of the works. In response to the message, the user terminal typically sends out a request to the remote content location. This request asks the remote content location to deliver the requested work to the user location.

In an alternative embodiment, the host may have forwarded the user's request to the remote content location and the next signal received by the user location may be the delivery of the requested work. The work may be delivered by streaming the electronic work to the specified address, downloading the requested work to the specified address, or any other method of distributing the work to the location.

In any embodiment, the requested work may be delivered directly from the content location to the user location or it may be delivered indirectly to the user location through the host.

### BRIEF DESCRIPTION OF THE DRAWINGS

The present invention is described with reference to the accompanying drawings. In the drawings, like reference numbers indicated identical or functionally similar elements.

FIG. 1 shows a block diagram of an embodiment of a system of the present invention;

FIG. 2 shows a flow chart of a method of the present invention;

FIG. 3 shows an exemplary data table generated in accordance with the present invention; and

FIG. 4 shows a flow chart of a method of the present invention.

### DETAILED DESCRIPTION OF THE PREFERRED EMBODIMENTS

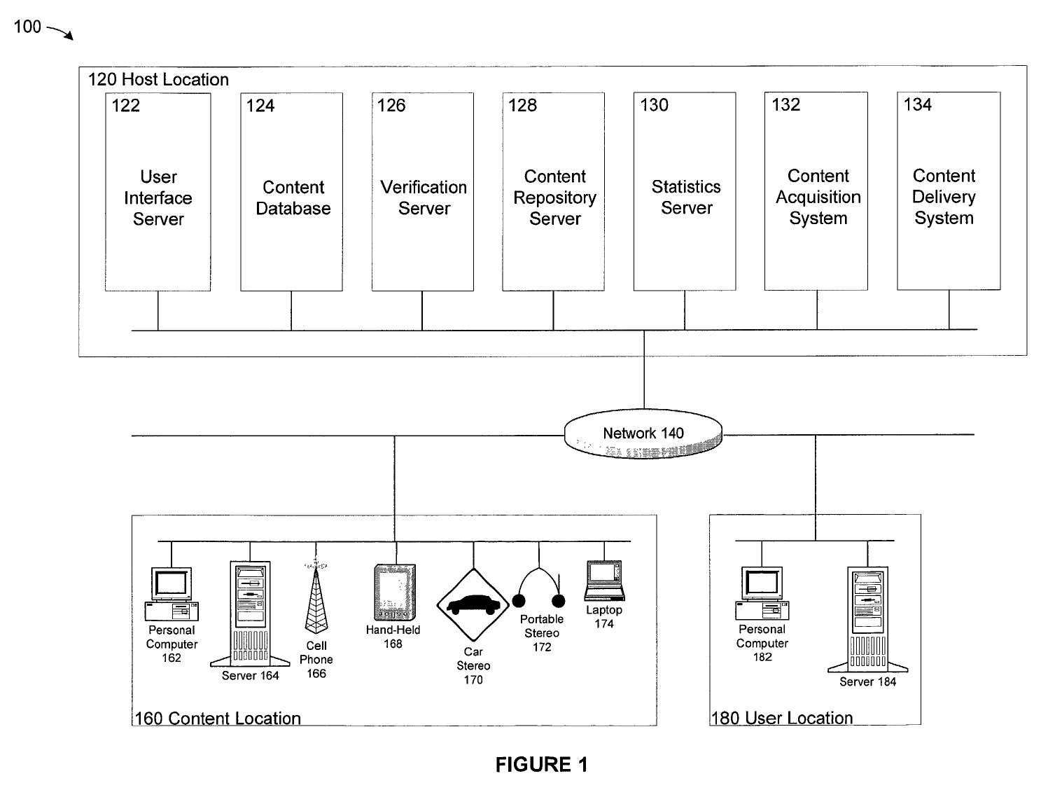

FIG. 1 shows an overview of a preferred embodiment of the present invention. As shown, the system 100 includes a host location 120, some exemplary content locations 160, and a user location 180. Each of the host location 120, the content locations 160 and the user location 180 is preferably enabled for communication with each of the others over a network 140. Note that the host location 120 shown here is also a content location. The host location 120, the content locations 160 and the user location 180 may be configured in a variety of different architectures, such as a client/server or a mainframe.

The network 140 is preferably the Internet, but may be any network, public, private or otherwise. The Internet is a network generally defined as a collection of processing systems and/or networks that are themselves globally networked together. The systems and networks of the global network are connected via any of a number of protocols, such as Transmission Control Protocol/Internet Protocol (“TCP/IP”). Internet Protocol (“IP”) is the basic communications language or protocol of the Internet. This and other related protocols provide for file transfer, remote log-in, electronic mail, and other services, including distributed processing, as well as other resources. HyperText Transfer Protocol (HTTP) is the set of rules for exchanging files (text, graphic images, sound, video and other multimedia files) on the Internet. Relative to the TCP/IP suite of protocols, HTTP is an application protocol.

HyperText Markup Language (HTML) is one convention that defines a set of symbols or codes inserted in a file intended for display on an Internet browser. The markup tells the web browser how to display a web page's words and images for the user. The hypertext conventions and related functions of the Internet are described in the appendices of U.S. Pat. No. 5,715,314, the entirety of which is herein incorporated by reference.

The host location 120 preferably provides a user with access to content or electronic works over the network 140. These electronic works may be audio files, video files, image files, audio-visual files, text files, games, or any other type of content file. In a preferred embodiment, the electronic works are accessible to the user via downloading, streaming or any other manner of retrieval from electronic memory.

In one embodiment, the host location 120 may include a user interface server 122, a content database 124, a verification server 126, a content repository server 128, a statistics server 130, a content acquisition system 132 and a content delivery system 134. The user interface server 122, the content database 124, the verification server 126, the content repository server 128, the statistics server 130, the content acquisition system 132 and the content delivery system 134 may be supported by a single server or a plurality of servers, depending on a size of the host location 120, a number of users, and other system requirements or characteristics. These servers may be connected via any local area network (LAN) technology, such as Ethernet, Fast Ethernet, Asynchronous Transfer Mode, Fiber Distributed Data Interface, Fiber Channel Interconnect, etc. In a preferred embodiment, the servers are connected via a LAN using 100 Base-T Ethernet technology.

The user interface server 122 preferably runs application software for a web site of the host location 120, performs certain transactions and processes certain requests associated with the web site, such as logins and content management.

In a preferred embodiment, the user interface server 122 is a dual Intel processor running a Linux operating system and Apache web server with mod_perl. A user interacts with the user interface server 122 when desiring to access their account or works. This interaction is done over HTTP using an HTML, Extensible Markup Language (“XML”), or a C Library. The user interface server 122 is accessible from anywhere the user has a connection to the network 140.

The content database 124 preferably stores information related to electronic works stored at the host location 120 and processes requests from user locations 180. In a preferred embodiment, the content database 124 is a dual Intel processor running a Linux operating system and MySQL database. The information stored therein may include meta-data, such as the titles of works, names of the artist, information about a band or performance, information about reviews of the work, UPC data, or any other information about the works. For example, if a work is a movie, the content database 124 may include a preview of the movie or information about its sound track. This information may be manually entered into the database or provided with the content.

The verification server 126 preferably verifies that a user is authorized to access a requested electronic work. The verification server 126 may perform a variety of tests or comparisons to determine whether a user is authorized to access a work. The manner of verification may include proving ownership of a physical copy of the work, providing an appropriate confirmation, and/or receiving authorization from the retailer that sold the work to the user. Also, the host may secure ownership to the works identified in a user account based on information from the user terminal. The verification and security techniques are described in more detail in U.S. Provisional Application No. 60/175,159, entitled SYSTEM AND METHOD FOR ENABLING GLOBAL ACCESS AND INSTANTANEOUS LISTENING TO DIGITAL AUDIO, filed Jan. 7, 2000, and U.S. Nonprovisional Application No. 09/615,591, entitled a SYSTEM AND METHOD FOR PROVIDING ACCESS TO ELECTRONIC WORKS, filed on Jul. 13, 2000, both incorporated herein by reference.

The verification and security techniques may be used for content stored at the host location 120 and content stored at remote content locations 160. If the content is stored remotely, the verification preferably occurs before the remote content is linked with the user account. In alternative embodiments, however, the verification or security techniques may occur sometime before the host instructs the remote content location 160 to provide the work to the user with access to the electronic work.

In a preferred embodiment, the verification server 126 is a dual Intel processor running a Linux operating system, Apache web server, and MySQL database. The verification server 126 also runs a Perl program as a common gateway interface (“CGI”). To perform its verification, the verification server 126 may read data from the content database 124 or content repository server 128.

The content repository server 128 preferably stores content and verification data, such as encoded content, sample data, and index data. In a preferred embodiment, the content repository server 128 is a Sun Solaris E450 server with a Redundant Array of Inexpensive Disk (“RAID”) as storage and a Veritas file system. The content and verification data may be accessed by the user interface server 122 or the verification server 126.

The statistics server 130 preferably collects data about the electronic works or host 120, such as how many users have access to a work, how many works are available from each artist, how many works are available for each type or category of works, what works are the most popular, what are users' typical click streams, what works are linked through remote content locations 160, how many times each work (i.e. works stored at the host 120 and works stored at remote content locations 160) is accessed, or any other useful data. For example, the statistics server 130 may receive information from a user location 180, such as what and how often works are streamed, downloaded, or played. The statistics server 130 may record this information so that the artists are compensated based on how often their works are accessed. The statistics server 130 could also collect a variety of other data, such as data related to billing or advertising.

In another embodiment, the statistics server 130 maintains a database with user information, such as how often users access the web site of the host location 120, what types of works users access the most, what are users' typical click streams or any other useful information. This information may be used to make the system more user-friendly, target advertising or promotions, etc.

The content acquisition system 132 preferably acquires content for the host location 120. The content acquisition system 132 may only include a single computer with a ripper and encoder. However, as the volume of works being added to the system increases, it may be necessary to implement a database-mediated, multi-machine parallel distributed-load architecture to rapidly extract content from different forms of media, such as tapes, CDs, DVDs, etc. The content acquisition system 132 is described in more detail in U.S. Provisional Application No. 60/175,159, entitled SYSTEM AND METHOD FOR ENABLING GLOBAL ACCESS AND INSTANTANEOUS LISTENING TO DIGITAL AUDIO, filed Jan. 7, 2000, and U.S. Nonprovisional Application No. 09/615,591, entitled a SYSTEM AND METHOD FOR PROVIDING ACCESS TO ELECTRONIC WORKS, filed on Jul. 13, 2000, both incorporated herein by reference.

The content locations 160 represent any location where electronic works are stored and accessible via the network 140, including a personal content location, such as a home or work personal computer, or a second host or web site where the user also has an account. The user location 180 represents any potential user of the system. The content locations 160 and the user locations 180 typically include a user terminal, server, or a plurality of servers similar to the host 120. In a preferred embodiment, the content locations are user terminals. A user terminal may include a personal computer or may include any of a variety of portable devices, such as a cell phone 166, hand held unit 168 (e.g., a Palm Pilot®), a car stereo 170, a portable stereo 172 (e.g., a Walkman®), etc., configured to interact over the network 140. The content locations 160 are preferably connected to the network 140 via a high speed connection, such as a digital subscriber line (“DSL”) or a cable modem.

A user terminal, such as personal computers 162 and 182, preferably runs an Internet browser, such as Microsoft Internet Explorer® or Netscape Navigator®. A browser system is a program that provides a way to locate information on the Internet. A browser typically interprets hypertext links, or simple “links,” and allows the user to view sites and navigate from one Internet node to another Internet node. A brief overview of web browsers and their interactions is set forth in U.S. Pat. No. 5,774,670, the entirety of which is incorporated by reference. Browsing also refers to the process of moving between HTML pages of a single typical web site. The HTML web page files, or web pages, may include a “homepage.” A “homepage” is the main page of a web site that typically names and describes the site, and provides links to other web pages or various other features of the web site. Clicking refers to the process of indicating a desired link by using a cursor control device, such as a mouse or roller ball.

The user location 180 is any location with access to the network 140. The user location 180 is typically a user terminal as described above. The user location 180 accesses the user's account with the host 120 from the user location 180 and requests access to a specific work in the account. In response to this request, the host 120 and/or content location 160 provides the requested work to the user location 180. The user location 180 is preferably connected to the network 140 via a high speed connection, such as DSL or a cable modem.

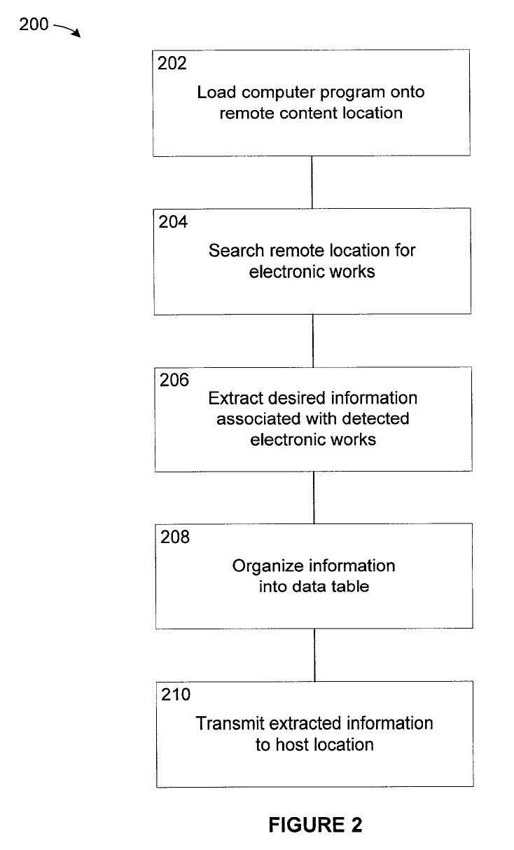

A preferred embodiment of the present invention in operation is shown in FIGS. 2, 3 and 4. In this embodiment, a user has an online account with the host 120. The on-line account preferably provides the user with access to electronic works stored at the host 120 and electronic works stored by at least one remote content location 160. In an alternative embodiment, the account may only provide the user with access to electronic works stored at the host 120 or one or more remote content locations 160.

FIG. 2 illustrates a method 200 of the present invention. In a preferred embodiment, the user preferably loads a computer program onto a remote content location 160 in step 202. The software may be downloaded over the network 140 from the host 120 or supplied on a portable medium, such as a CD-ROM. As will be further discussed below, this software may further support server functionality.

Once the software is loaded at the remote content location 160, the program may ask the user to input some information, such as the username and password associated with the user's account with the host 120, where at the remote content location 160 electronic works are stored, and possibly other information about the user's account or electronic works.

After this information is provided, the computer program may, in step 204, search the remote location 160, either automatically or at the user's direction, for the electronic works stored at the content location 160. The program may search for the files identified by the user, may search for files identified by a predetermined file type, such as rich text format (RTF) or MP3 files, may search for specific file names, or may search for any other type of characteristic that identifies content. The program may also search the content location 160 for links to content stored at other network locations. Further, the program may search all of the memory at the remote content location 160, may only search specific drives (e.g., a drive, c drive, etc.), may only search specific folders, etc.

In step 206, upon detection of electronic works of the desired type, the program at the remote content location 160 preferably extracts certain information associated with the works, such as meta-data. Perferably, the musical electronic works stored at the remote content location 160 are stored with meta-data compliant with ID3 version 1 or 2, such as the title of the work, the name of the artist, the name of the album, the genre of the music, the track number of the song, etc. In an alternative embodiment, the meta data may also include the name of the movie, title of the picture, name of the book, artwork associated with the work, digital watermarks, or any other potentially useful information.

In yet another embodiment, the electronic work may not include well-structured meta-data, and the program may create meta-data from contextual information associated with the file, such as the file name, the file location, the header, or from other meta-data associated with the file. In addition, the program may ask the user for additional information about the file to create more meta-data for a work.

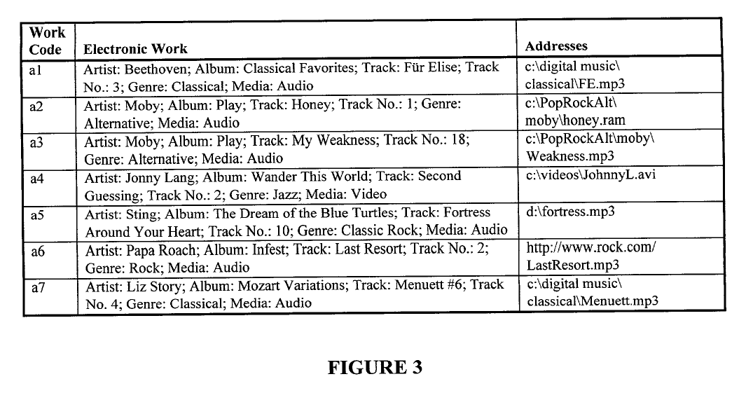

Once the program locates and extracts all the necessary information, the program organizes this information into a data table in step 208. As shown in FIG. 3, the data table preferably includes an assigned identifier or work code for each work, certain meta-data about the work and an address or specific location of the work at the remote content location 160. Note that the identifier may be a link to content stored at another network location or another host. For example, the program may search not only for electronic works physically stored at the remote content location 160, but may also search for links, found at the content location 160, to content stored anywhere on the network 140. In one embodiment, the program searches folders for bookmarks or other links pointing to electronic works stored or accessible at other network locations, and stores these bookmarks or links as electronic work locations. Thus, the program may automatically, or at a direction of the user, search for links to other audio or video files.

The work code is preferably a unique identifier. The program may assign the work codes sequentially, incrementally, randomly, or in any other way. FIG. 3 shows, by way of example, that the meta-data includes the artist, album, track, track number, genre and media type. Of course, other types of information are contemplated as well, including work format, compression ratio, work size, streaming data rate, etc. The table may include some or all of the meta-data associated with the work. This remote content location 160 may store this table on a hard drive, server, or any other type of memory, such as RAM, EEPROM, FLASH, etc.

In step 210, some or all of the information gathered in step 206 is preferably transmitted to the host location 120. The transmission may occur automatically after the search is complete or the user may initiate the transmission by selecting an icon on a user interface. In a preferred embodiment, the transmission includes the user identification information, the assigned identifier for at least one electronic work, and the address of the remote content location 160. Since some host locations 120 shut down a user's account if they detect more than one login at the same time, the transmission may also distinguish itself from a normal user login. Some ways to distinguish a login for a remote content location from a login for the user are a header, data file, or the method of receipt.

The address for the remote content location 160 is preferably an Internet protocol (“IP”) address. In one embodiment, the address of a remote content location 160 may change periodically, such as when the remote content location 160 communicates with the network 140 via a cable modem. To accommodate for these changes, the remote content location 160 may periodically update its address information with the host 120. The remote content location 160 may update such information at the user's command. The updates may also occur automatically, only when necessary, during each transmission to the host 120, or when the host 120 contacts the remote content location 160. The need for such updates depends on a stability of a user's address.

Upon receipt of this transmission, the host 120 may verify that the user or account holder is authorized to access the electronic works identified in the transmission. The host 120 may verify such authorization, such as via a confirmation number, a message received from a retailer, or in any other desired manner. Illustrative examples of such verification means are disclosed in U.S. Provisional Application No. 60/175,159, entitled SYSTEM AND METHOD FOR ENABLING GLOBAL ACCESS AND INSTANTANEOUS LISTENING TO DIGITAL AUDIO, filed Jan. 7, 2000, and U.S. Nonprovisional Application No. 09/615,591, entitled a SYSTEM AND METHOD FOR PROVIDING ACCESS TO ELECTRONIC WORKS, filed on Jul. 13, 2000, both incorporated by reference above. In another embodiment, the host 120 may request information from the user or from the remote content location 160 that identifies where the user purchased the stored work and the host 120 may contact the retailer that sold the work or receive an authorization message directly from the retailer. The type of information required from the retailer is discussed in more detail in U.S. Provisional Application No. 60/175,159, entitled SYSTEM AND METHOD FOR ENABLING GLOBAL ACCESS AND INSTANTANEOUS LISTENING TO DIGITAL AUDIO, filed Jan. 7, 2000, and U.S. Nonprovisional Application No. 09/615,591, entitled a SYSTEM AND METHOD FOR PROVIDING ACCESS TO ELECTRONIC WORKS, filed on Jul. 13, 2000, both incorporated herein by reference above.

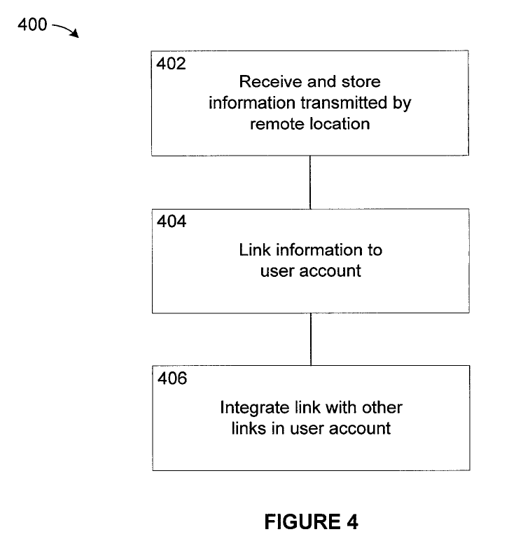

FIG. 4 shows a method 400 of the present invention from a perspective of the host 120. In step 402, the host location 120 receives and stores the transmission discussed above from the content location 160. The host 120 or user interface server 122 uses the user identification information to identify the user's account and for verification that the remote content location 160 should have access.

In step 404, the host 120 links the information, such as the identifier or work codes, meta-data, and remote content location address, to the account. In one embodiment, the host 120 maintains one or more databases or other organizational structures related to user accounts. The database may be organized in a variety of ways. For example, the database may contain a table for all of the various sources of content, such as a table for remote content, a table for works authorized via a retailer, a table for publicly available works, a table of works available via a subscription, etc. Each table lists the account identifier for users with access to an electronic work via that means and the identification of the authorized work. For example, the remote content location database may list the account identification for users with access to works stored at a remote location 160 and the identifier of that work or groups of works. These tables may also list various additional information.

In one embodiment, the tables may group the works by a variety of categories to reduce the number of entries. For example, the table may only list the name of a compact disc, and the identification of that compact disc may point to another table identifying the works on that compact disc to permit the user to access all the works on that compact disk. Also, the identification may not point to another table, but the identification of the compact disc itself may permit the user to access those works. In another embodiment, the table may only identify the content location 160, and the identification of that content location 160 may permit the user to access all or some of the content or works at that content location 160. When a user accesses his or her account, the host scans the various tables and creates a list of all the works available to that user.

In alternative embodiments, the database structures may vary considerably. For example, the database may contain tables for each account, tables for each recording company, tables for each subscription, or the tables may be organized in any hierarchical manner.

When a new work is added to a user's account, the linking of step 404 may occur by adding another entry to one of these tables. The entry would list the user's account identification, the identification of the new work, and any other potentially useful information. As discussed above, the identification of the work may include an address of the content location 160 storing the work and/or other information.

The host 120 may also link an account to multiple remote content locations 160. For example, a user may want to link his or her account to the works stored on a personal computer at home and the works stored on a personal computer at the office. In an alternative embodiment, each account is only linked to one remote content location 160. Similarly, a remote content location 160 may be linked to multiple user accounts at a single host or multiple hosts 120. In a preferred embodiment, however, each remote content location 160 is linked to only one account.

Once electronic works stored at the content location 160 are linked to the account, the links are preferably integrated with similar links to content made accessible to the account through other means in step 406. For example, an account may have access to a work because a user owns a physical copy of the work or an account may have access to works because they were purchased from an authorized retailer, as in U.S. Provisional Application No. 60/175,159, entitled SYSTEM AND METHOD FOR ENABLING GLOBAL ACCESS AND INSTANTANEOUS LISTENING TO DIGITAL AUDIO, filed Jan. 7, 2000, and U.S. Nonprovisional Application No. 09/615,591, entitled a SYSTEM AND METHOD FOR PROVIDING ACCESS TO ELECTRONIC WORKS, filed on Jul. 13, 2000, both incorporated herein by reference above. Also, an account may have access to works because of a subscription, as shown in U.S. Nonprovisional Application No. 09/722,407, entitled A SUBSCRIPTION RIGHTS AND ACCOUNTING SYSTEM, and filed on Nov. 28, 2000, herein incorporated by reference.

When links to content at the remote content location 160 are integrated with links to content accessible through other means, the user may consolidate all such content or electronic works into one account and access all of this content through one user interface. Each of the works is identifiable by a unique Uniform Resource Locator (“URL”). Each URL may be determined differently depending on how the corresponding work was authorized and/or the source thereof.

With the electronic works from various locations linked, the user may create a playlist including works from any of the integrated sources. For example, the host 120 allows the user to create a playlist with works stored at a remote content location 160 and works stored at the host 120, or to create a playlist with works stored at a remote content location 160, works authorized because of a physical copy of the work, works authorized because of a subscription, and works authorized because they were purchased through an authorized retailer.

The host 120 may also group or categorize the works from the various sources in the user account via artist, genre, actor, source, or any other desired categories. Thus, if the user wants to access all works by a certain author or artist from all available sources, the user interface server 122 may identify all of the works by that actor or author.

Once the works stored at multiple content locations 160 are integrated by the host 120, the user may access all of these works through his or her account. To access these works, the user may logon to the account with the user's identification information, such as a username and password. After the user logs on, the host 120 provides a user interface through which the user may view, group and/or access all of the user's works. The user may access the account from anywhere the user has access to the network 140. The user may request to access the works individually or through a playlist. If the user requests a work stored at a content location 160 other than the host 120, the host 120 creates or retrieves the URL for that work. As discussed above the URL indicates the identifier of the requested work and the address of the content location 160 that stores the work.

After the content location 160 having the requested work is linked to the account, that content location 160 listens on a network port for a message or request for a stored work. The request may be received from the host 120 or directly from a user location 180. Preferably, the content location 160 listens for requests using the HTTP protocol. However, other network protocols may be used as well. The content location 160 may listen continually or it may listen only when the user instructs it to listen.

When the user at a user location 180 selects a work stored at a remote content location 160, the host 120 generates a work code or other identifier for the requested work. The work code may be derived from the network address of the content location 160 storing the work and/or the location of the requested work at the content location 160.

In a preferred embodiment, the host 120 sends a message, which may include an address of the remote content location 160, a work code or other identifier of the requested work and/or a URL, back to the user location 180. The user location 180 may then use this identifier as well as any other information in the message to contact the content location 160 directly. In one embodiment, the URL is created based on the address of the remote content location 160 and the identifier of the work, such that the URL itself includes all of this information. The content location 160 uses the identifier to look up, such as in a look-up table of the type shown in FIG. 3, where at the content location 160 the requested work is stored. Once the content location 160 identifies where the requested work is stored, the content location 160 accesses the work and delivers the work to the user location 180. In a preferred embodiment, the content location 160 delivers the work by acting as a server, which is supported by the program loaded at the content location 160.

In an alternative embodiment, the host 120 sends a message or request with this identifier to the remote content location 160. In this embodiment, the message typically forwards the work code and the network address of the user location 180 so that the content location 160 knows where to send the work.

The work may be delivered by downloading or uploading the work to the user location 180, streaming the work to the user location 180, or any other means of electronic delivery. The requested work may be delivered by any method directly from the content location 160 to the user location 180 or indirectly through the host 120 to the user location 180.

The host 120 may also collect a variety of information from the delivery of this content. For example, the host 120 may collect users' preferences, such as what genres of works they access the most, or what artists of works they access the most. Based on these user preferences, the host 120 may send targeted advertisements or promotions. The host 120 may also collect information regarding what works are accessed to calculated and distribute royalties, or to charge users. Any royalty payments or charges may, for example, be tracked, calculated, and made based on a system of the type shown in U.S. Nonprovisional Application No. 09/722,407, entitled A SUBSCRIPTION AND ACCOUNTING SYSTEM, incorporated by reference above.

### CONCLUSION

While various embodiments of the present invention have been described above, it should be understood that they have been presented by way of example only, and not limitation. For example, the present invention is not limited to the physical arrangements or use with any particular network. As such, the breadth and scope of the present invention should not be limited to any of the above-described exemplary embodiments, but should be defined only in accordance with the following claims and their equivalents.

What is claimed is:

1. A method for integrating links to content at multiple sources, comprising the steps of:
providing an on-line account with access to a first electronic work, wherein the account is accessible based on a user identification, wherein a first identifier identifies the first electronic work, and wherein the first identifier is linked to the on-line account;
receiving the user identification, a second identifier for a second electronic work, and an address for a remote content location;
storing the second identifier and the address for the remote content location;
linking the second electronic work to the on-line account;
receiving a request for the second electronic work; and
sending a message identifying the second electronic work to a network location to initiate delivery of the second electronic work to a network location.

2. The method of claim 1, wherein the address for the remote location is an Internet protocol address.

3. The method of claim 1, wherein the step of receiving further includes receiving meta-data associated with the second electronic work.

4. The method of claim 1, wherein the second identifier is assigned to the second electronic work incrementally.

5. The method of claim 1, further comprising the step of updating the address of remote content location.

6. The method of claim 1, wherein the network location is an Internet protocol address.

7. The method of claim 1, wherein the steps occur in order.

8. The method of claim 1, wherein the account is linked to multiple remote content locations.

9. The method of claim 1, further comprising the steps of:
storing meta-data associated with the first electronic work;
receiving meta-data associated with the second electronic work from the remote content source; and
integrating the meta-data associated with the first electronic work with the meta-data associated with the second electronic work.

10. The method of claim 1, wherein the first electronic work was added to the on-line account after the user proved ownership of the first electronic work.

11. The method of claim 10, wherein the user proved ownership with a physical copy of the first electronic work.

12. The method of claim 1, wherein the first electronic work was added to the on-line account when authorization was received from a retailer.

13. The method of claim 1, wherein the network location is the user location.

14. The method of claim 1, wherein the message also identifies the address of the remote content location.

15. A method for integrating links to multiple sources of content, comprising the steps of:
scanning a memory in a remote content location for an electronic work, wherein the remote content location has an address;
assigning an identifier to the electronic work;
transmitting the identifier and the address of the remote content location to a central location;
receiving a request for the electronic work from the central location, wherein the request includes an instruction to provide the electronic work to a specified location;
retrieving the electronic work from memory; and
providing the electronic work to the specified location.

16. The method of claim 15, further comprising the step of extracting meta-data from the electronic work.

17. The method of claim 15, wherein the step of transmitting also transmits at least some meta-data to the central location.

18. The method of claim 15, further comprising the step of inserting the assigned identifier, a file name, and a local address into a look-up table.

19. The method of claim 15, wherein the step of scanning scans the memory for files with certain characteristics.

20. The method of claim 15, wherein the electronic work has a file name, and
claim 15 further comprises the step of generating meta-data for the electronic work based on the file name.

21. The method of claim 15, wherein step of assigning is done incrementally.

22. A system for integrating links to content at multiple sources, comprising:
means for providing an on-line account with access to a first electronic work, wherein the account is accessible based on a user identification, wherein a first identifier identifies the first electronic work, and wherein the first identifier is linked to the on-line account;
means for receiving the user identification, a second identifier for a second electronic work, and an address for a remote content location;
means for storing the second identifier and the address for the remote content location;
means for linking the second electronic work to the on-line account;
means for receiving a request for the second electronic work; and
means for sending a message identifying the second electronic work to a network location to initiate delivery of the second electronic work to a network location.

23. A computer program product comprising a computer useable medium having computer a program logic recorded thereon for enabling a processor in a computer system to integrate links to content at multiple sources, said computer program logic comprising:
providing means for enabling the processor to provide an on-line account with access to a first electronic work, wherein the account is accessible based on a user identification, wherein a first identifier identifies the first electronic work, and wherein the first identifier is linked to the on-line account;
receiving means for enabling the processor to receive the user identification, a second identifier for a second electronic work, and an address for a remote content location;
storing means for enabling the processor to store the second identifier and the address for the remote content location;
linking means for enabling the processor to link the second electronic work to the on-line account;
receiving means for enabling the processor to receive a request for the second electronic work; and
sending means for enabling the processor to send a message identifying the second electronic work to a network location to initiate delivery of the second electronic work to a network location.

24. A system for integrating links to multiple sources of content, comprising:
means for scanning a memory in a remote content location for an electronic work, wherein the remote content location has an address;
means for assigning an identifier to the electronic work;
means for transmitting the identifier and the address of the remote content location to a central location;
means for receiving a request for the electronic work from the central location, wherein the request includes an instruction to provide the electronic work to a specified location;
means for retrieving the electronic work from memory; and
means for providing the electronic work to the specified location.

25. A computer program product comprising a computer useable medium having computer program logic recorded thereon for enabling a processor in a computer system to integrate links to multiple sources of content, said computer program logic comprising:
scanning means for enabling the processor to scan a memory in a remote content location for an electronic work, wherein the remote content location has an address;
assigning means for enabling the processor to assign an identifier to the electronic work;
transmitting means for enabling the processor to transmit the identifier and the address of the remote content location to a central location;
receiving means for enabling the processor to receive a request for the electronic work from the central location, wherein the request includes an instruction to provide the electronic work to a specified location;
retrieving means for enabling the processor to retrieve the electronic work from memory; and
providing means for enabling the processor to provide the electronic work to the specified location.
